(19) United States
(12) Patent Application Publication
(10) Pub. No.: US 2026/0250610 A1
(43) Pub. Date: Aug. 27, 2026

(54) WATER-SOLUBLE FILM FOR LIQUID DETERGENT PACKAGE CAPSULE, AND LIQUID DETERGENT PACKAGE CAPSULE

(71) Applicant: AICELLO CORPORATION, Aichi (JP)

(72) Inventors: Hirokazu OHSAWA, Aichi (JP); Yuta WASHIO, Aichi (JP); Keiichi SHIMIZU, Aichi (JP)

(73) Assignee: AICELLO CORPORATION, Aichi (JP)

(21) Appl. No.: 19/160,270

(22) PCT Filed: Feb. 22, 2024
(86) PCT No.: PCT/JP2024/006515

§ 371 Date: Aug. 27, 2025

(30) Foreign Application Priority Data
Feb. 28, 2023 (JP) 2023-030047

(51) Int. Cl. C11D 17/04; C11D 1/34; C11D 3/00; C11D 3/20; C11D 3/37

(52) U.S. Cl. CPC C11D 17/043; C11D 1/345; C11D 3/0084; C11D 3/2065; C11D 3/2068; C11D 3/3707; C11D 3/3753; C11D 17/044; C11D 2111/14

(57) ABSTRACT

The present invention relates to a water-soluble film containing: an anionic group-modified polyvinyl alcohol resin; and a plasticizer including sorbitol and a polymer consisting of polyethylene glycol and/or polyglycerin, in which a content of the sorbitol is 6 parts by mass to 15 parts by mass, a content of the polymer is 3 parts by mass to 15 parts by mass, and a content of the plasticizer is 25 parts by mass to 50 parts by mass with respect to 100 parts by mass of the anionic group-modified polyvinyl alcohol resin.

### TECHNICAL FIELD

The present invention relates to a water-soluble film for a detergent package capsule and a detergent package capsule.

### BACKGROUND ART

As a detergent package capsule for enclosing a powder detergent or a liquid detergent such as a laundry detergent, a dish detergent, or a household care composition, one formed by bonding predetermined portions of a water-soluble film containing a polyvinyl alcohol resin as a main ingredient has been used. When the package capsule with a detergent enclosed is used for, for example, washing, at least a part of the package capsule is dissolved in water at a start of washing, and the detergent is released to form a washing liquid. During the washing, the package capsule is dissolved in the washing liquid and discharged together with the washing liquid after the washing is completed.

As described in the following Patent Literature 1, a water-soluble film used in such a detergent package capsule contains a plasticizer such as sorbitol to impart the film with proper flexibility and to facilitate processing such as vacuum molding (thermoforming) at the time of producing the detergent package capsule. Furthermore, the detergent package capsule which is formed of the water-soluble film containing sorbitol as a plasticizer and in which a powder detergent is enclosed can prevent breakage due to film embrittlement caused by migration of the plasticizer to a powder detergent.

However, in the case where a large amount of sorbitol as a plasticizer is blended into a water-soluble film for a detergent package capsule to improve molding processability of the water-soluble film and to prevent breakage of a detergent package capsule with a powder detergent enclosed, when the water-soluble film is stored in a film state, there is a possibility that sorbitol precipitates on a film surface and impairs an appearance, so that a storage period has to be shortened. Furthermore, it has been found that if the amount of the plasticizer such as sorbitol in a water-soluble film is reduced, haptics of the film forming a capsule may decrease in a detergent package capsule with a liquid detergent enclosed.

### CITATION LIST

### Patent Literature

Patent Literature 1: WO2017/043510

### SUMMARY OF INVENTION

### Technical Problem

The present invention has been made to solve the above problems, and thus an object thereof is to provide a detergent package capsule and a water-soluble film for a detergent package capsule that can prevent sorbitol from precipitating on a film surface during long-term storage even in a water-soluble film in which sorbitol or the like is blended as a plasticizer to achieve molding processability of the water-soluble film for a detergent package capsule and prevent breakage in the detergent package capsule with a powder detergent enclosed, and that can maintain haptics of the formed film even in a detergent package capsule with a liquid detergent enclosed.

### Solution to Problem

A water-soluble film for a detergent package capsule that can achieve the above object is a water-soluble film containing: an anionic group-modified polyvinyl alcohol resin; and a plasticizer including sorbitol and a polymer consisting of polyethylene glycol and/or polyglycerin, in which a content of the sorbitol is 6 parts by mass to 15 parts by mass, a content of the polymer is 3 parts by mass to 15 parts by mass, and a content of the plasticizer is 25 parts by mass to 50 parts by mass with respect to 100 parts by mass of the anionic group-modified polyvinyl alcohol resin.

In the water-soluble film, it is preferable that the anionic group-modified polyvinyl alcohol resin has a modification type of maleic acid modification and a degree of modification of 0.5 mol % to 6.0 mol %, because solubility of the detergent package capsule in water can be improved.

In the water-soluble film, it is preferable that the total content of the sorbitol and the polymer consisting of the polyethylene glycol and/or the polyglycerin be 18 parts by mass to 30 parts by mass with respect to 100 parts by mass of the anionic group-modified polyvinyl alcohol resin, because breakage of a powder detergent package capsule due to film embrittlement caused by migration of the plasticizer to a powder detergent can be prevented.

In the water-soluble film, it is preferable that the plasticizer contains glycerin, and the content of the glycerin is 1 part by mass to 32 parts by mass with respect to 100 parts by mass of the anionic group-modified polyvinyl alcohol resin, because molding processability of the water-soluble film for a detergent package capsule can be further improved.

In the water-soluble film, it is preferable that the water-soluble film further includes a sulfite, and the content of the sulfite is 0.1 parts by mass to 1.9 parts by mass with respect to 100 parts by mass of the anionic group-modified polyvinyl alcohol resin, because discoloration caused by heating or the like during molding of a detergent package capsule can be prevented.

In the water-soluble film, it is preferable that the sulfite is sodium sulfite.

In the water-soluble film, when a capsule formed using the water-soluble film for a detergent package capsule is vacuum-molded with a box-shaped cavity having an opening area of 2000 mm², a depth of 15 mm, and rounded corners, and 22 mL of a liquid detergent containing 72.9 mass % of a surfactant, 5.1 mass % of glycerin, 14.5 mass % of polyethylene glycol (PEG 400), and 7.5 mass % of water is enclosed in the capsule, a height retention rate is 86% or more after storage for 7 days at 23° C. and 50% RH, the surfactant containing a polyoxyethylene alkyl ether, a linear alkylbenzene sulfonate, an alkyl ether sulfate ester salt, and a polyethylene glycol monolaurate.

In the water-soluble film, when a 165 mm×65 mm flat bag formed of the water-soluble film for a detergent package capsule is filled with 35 g of sodium carbonate, the water-soluble film in contact with a powder detergent ingredient obtained after exposure and storage for 7 days in an environment of 50° C. and 50% RH has a tensile modulus in a tensile modulus measurement test of less than 220 MPa.

A detergent package capsule that can achieve the above object includes a capsule formed of the above-described water-soluble film for a detergent package capsule and a liquid detergent and/or a powder detergent enclosed in the capsule.

### Advantageous Effects of Invention

According to the water-soluble film for a detergent package capsule according to the present invention, the sorbitol can be prevent from precipitating on a film surface during long-term storage, molding processability during production of the detergent package capsule can be maintained. In addition, an effect of reducing embrittlement can be exhibited by preventing breakage of the detergent package capsule with a powder detergent enclosed while solubility after package of the powder detergent is excellent. In addition, discoloration, particularly yellowing, after enclosing the powder detergent is not caused, and haptics of a film for forming the detergent package capsule with a liquid detergent enclosed can also be maintained.

### DESCRIPTION OF EMBODIMENTS

A water-soluble film for a detergent package capsule (hereinafter, simply referred to as a water-soluble film) of the present invention is mainly formed of an anionic group-modified polyvinyl alcohol resin. The anionic group-modified polyvinyl alcohol resin is not particularly limited, and examples thereof include a maleic acid-modified polyvinyl alcohol resin, an itaconic acid-modified polyvinyl alcohol resin, an acrylic acid-modified polyvinyl alcohol resin, a methacrylic acid-modified polyvinyl alcohol resin, and a 2-acrylamido-2-methylpropanesulfonic acid-modified polyvinyl alcohol resin.

In the anionic group-modified polyvinyl alcohol resin, a ratio (degree of modification) of the number of moles of monomers reacted for modification to the number of moles of all monomers constituting the anionic group-modified polyvinyl alcohol resin is preferably 0.5 mol % to 6.0 mol %, more preferably 0.5 mol % to 4.0 mol %, and furthermore preferably 0.5 mol % to 2.0 mol %. In the case where the degree of modification of the anionic group-modified polyvinyl alcohol resin is less than 0.5 mol %, solubility in water tends to decrease, whereas in the case where the degree of modification is more than 6.0 mol %, productivity of the anionic group-modified polyvinyl alcohol resin tends to decrease.

In particular, it is preferable that in the anionic group-modified polyvinyl alcohol resin, a modification type is maleic acid modification, and a degree of modification is 0.5 mol % to 2.0 mol %, because the solubility of the detergent package capsule in water can be improved.

The anionic group-modified polyvinyl alcohol resin can be obtained by performing polymerization by a known method such as a solution polymerization method, a bulk polymerization method, or a suspension polymerization method to obtain a polymer and then saponifying the polymer. The saponification is performed by using an alkali or an acid, and it is particularly preferable to use an alkali. A degree of saponification (average degree of saponification) is not particularly limited, but is preferably in a range of 86 mol % to 100 mol % because the solubility in water is easily adjusted, more preferably 87 mol % to 99 mol %, and furthermore preferably 88 mol % to 94 mol %. In the case where the degree of saponification is less than 86 mol %, the water solubility of the anionic group-modified polyvinyl alcohol resin tends to decrease. The degree of saponification is measured according to JIS K6726 (1994).

The anionic group-modified polyvinyl alcohol resin used in the present invention may contain a repeating unit constituted by the following monomers within a range in which effects of the present invention are not impaired. Examples of the monomers include olefins such as ethylene, propylene, isobutylene, α-octene, α-dodecene, and α-octadecene, complete alkyl esters of unsaturated acids such as acrylic acid, methacrylic acid, crotonic acid, maleic acid, maleic anhydride, and itaconic acid, nitriles such as acrylonitrile and methacrylonitrile, amides such as acrylamide and methacrylamide, alkylvinylethers, N-acrylamidemethyltrimethyl ammonium chloride, allyltrimethylammonium chloride, dimethyldiallylammonium chloride, dimethylallyl vinyl ketone, N-vinylpyrrolidone, vinyl chloride, vinylidene chloride, polyoxyalkylene (meth)allyl ethers such as polyoxyethylene (meth)allyl ether and polyoxypropylene (meth)allyl ether, polyoxyalkylene (meth)acrylates such as polyoxyethylene (meth)acrylate and polyoxypropylene (meth)acrylate, polyoxyalkylene (meth)acrylamides such as polyoxyethylene (meth)acrylamide and polyoxypropylene (meth)acrylamide, polyoxyethylene (1-(meth)acrylamide-1,1-dimethyl propyl) ester, polyoxyethylene vinyl ether, polyoxypropylene vinyl ether, polyoxyethylene allylamine, polyoxypropylene allylamine, polyoxyethylene vinylamine, polyoxypropylene vinylamine, and diacrylacetonamide.

In addition, examples thereof further include cationic group-containing monomers such as N-acrylamidomethyltrimethylammonium chloride, N-acrylamidoethyltrimethylammonium chloride, N-acrylamidopropyltrimethylammonium chloride, 2-acryloxyethyltrimethylammonium chloride, 2-methacryloxyethyltrimethylammonium chloride, 2-hydroxy-3-methacryloyloxypropyltrimethylammonium chloride, allyltrimethylammonium chloride, methallyltrimethylammonium chloride, 3-butenetrimethylammonium chloride, dimethyldiallylammonium chloride, and diethyldiallylammonium chloride.

A degree of polymerization of the anionic group-modified polyvinyl alcohol resin is preferably 700 or more, more preferably 900 or more, and furthermore preferably 1200 or more. In the case where the degree of polymerization is less than 700, the mechanical property of the water-soluble film and the pressure-resisting strength of the finally obtained liquid detergent package capsule tend to decrease. An upper limit of the degree of polymerization is preferably 2500, more preferably 900 or more and 2200 or less, and furthermore preferably 1200 or more and 1700 or less. In the case where the degree of polymerization is more than 2500, the water solubility of the water-soluble film tends to decrease.

A 4 mass % aqueous solution viscosity of the anionic group-modified polyvinyl alcohol resin at 20° C. is not particularly limited but is preferably 7.0 mPa·s to 55 mPa·s, more preferably 9.0 mPa·s to 50 mPa·s, and furthermore preferably 12 mPa·s to 35 mPa·s. The 4 mass % aqueous solution viscosity is measured according to JIS K6726 (1994).

The content of the anionic group-modified polyvinyl alcohol resin in 100 parts by mass of the water-soluble film of the present invention is preferably 69 parts by mass to 97 parts by mass, and more preferably 60 parts by mass to 80 parts by mass, because a content of water in the water-soluble film can be easily adjusted to an appropriate range. In the case where the content is less than 60 parts by mass, a tensile strength of the water-soluble film may be insufficient, whereas in the case where the content is more than 80 parts by mass, flexibility of the water-soluble film may be insufficient.

A plurality of types of anionic group-modified polyvinyl alcohol resins may be used in the water-soluble film according to the present invention. In this case, anionic group-modified polyvinyl alcohols that differ in at least one of molecular weight, degree of polymerization, 4 mass % aqueous solution viscosity, degree of saponification, degree of modification, modification type, and the like can be adopted. Other modified polyvinyl alcohol resins and/or unmodified polyvinyl alcohol may be contained as necessary within a range in which the object of the present invention is not impaired.

The water-soluble film of the present invention contains, as a plasticizer, sorbitol and a polymer consisting of polyethylene glycol and/or polyglycerin. The sorbitol is a sugar alcohol with a melting point of 80° C. or higher. Generally, even in the anionic group-modified polyvinyl alcohol resin which is a water-soluble resin used for molding a capsule, a plasticizer used to ensure ease of molding is blended, and when a powder detergent is enclosed in a capsule formed by a water-soluble film containing the plasticizer, the plasticizer in the water-soluble film may migrate to the powder detergent, causing the water-soluble film to become brittle and resulting in breakage.

In this regard, the capsule formed by a water-soluble film containing sorbitol as the plasticizer can prevent the migration of sorbitol to the powder detergent, and can prevent the embrittlement of the water-soluble film caused by the migration of the plasticizer. However, in a water-soluble film containing a large amount of sorbitol to ensure the molding processability, sorbitol may precipitate on a surface of the water-soluble film over time during storage, impairing transparency of the water-soluble film.

In order to prevent such precipitation of sorbitol during the storage and to maintain the molding processability, the content of sorbitol is preferably 6 parts by mass to 15 parts by mass, more preferably 7 parts by mass to 13 parts by mass, and furthermore preferably 8 parts by mass to 11 parts by mass with respect to 100 parts by mass of the anionic group-modified polyvinyl alcohol resin. In the water-soluble film in which the content of sorbitol is less than 6 parts by mass, the molding processability is reduced, whereas in the water-soluble film in which the content of sorbitol is more than 15 parts by mass, the transparency is reduced due to the precipitation of sorbitol during the storage.

In the water-soluble film of the present invention, in addition to sorbitol, a polymer consisting of polyethylene glycol and/or polyglycerin is also contained as the plasticizer. The polyethylene glycol preferably has a weight average molecular weight (hereinafter simply referred to as an average molecular weight) of 106 or more, more preferably 150 to 400, and particularly preferably 200. Those having an average molecular weight of less than 106 tend to volatilize easily from the water-soluble film, and those having an average molecular weight of more than 400 tend to have a low compatibility with the anionic group-modified polyvinyl alcohol resin. The polyglycerin preferably has a molecular weight of 166 to 750 and more preferably 166 to 500, and diglycerin having a molecular weight of 166 is particularly preferable. Those having a molecular weight of more than 750 tend to have a low compatibility with the anionic group-modified polyvinyl alcohol resin.

Such a polymer can contribute to improving the molding processability of the water-soluble film, and is difficult to migrate to the powder detergent enclosed in a capsule made of the water-soluble film due to steric hindrance thereof. However, in the water-soluble film containing a large amount of polymer, the capsule with the powder detergent enclosed may turn yellow. It is presumed that this phenomenon is caused by a matter that the polymer in the water-soluble film traps oxygen in the capsule with the powder detergent enclosed and promotes oxidation of ingredients in the water-soluble film. For this reason, in order to prevent yellowing of the water-soluble film of the capsule with the powder detergent enclosed while improving the molding processability of the water-soluble film, it is necessary to set the content of the polymer, which is polyethylene glycol and/or polyglycerin, to 3 parts by mass to 15 parts by mass, preferably 5 parts by mass to 15 parts by mass, and more preferably 8 parts by mass to 15 parts by mass with respect to 100 parts by mass of the anionic group-modified polyvinyl alcohol resin. In the case where the content of the polymer is less than 3 parts by mass, it becomes difficult to improve the molding processability of the water-soluble film, whereas in the case where the content of the polymer is more than 15 parts by mass, the water-soluble film of the capsule with the powder detergent enclosed becomes easy to turn yellow.

Furthermore, in the case where the total content of sorbitol and the polymer consisting of polyethylene glycol and/or polyglycerin is 18 parts by mass to 30 parts by mass, more preferably 18 parts by mass to 28 parts by mass, and furthermore preferably 18 parts by mass to 25 parts by mass with respect to 100 parts by mass of the anionic group-modified polyvinyl alcohol resin, it is possible to prevent the breakage due to the embrittlement of the water-soluble film caused by the migration of the plasticizer to the powder detergent.

Either polyethylene glycol or polyglycerin may be used alone, or polyethylene glycol and polyglycerin may be used in combination as the polymer.

From a viewpoint of the flexibility of the finally obtained package capsule, the water-soluble film may contain glycerin as the plasticizer. In the case where the content of glycerin is 1 part by mass to 32 parts by mass, more preferably 5 parts by mass to 25 parts by mass, and furthermore preferably 5 parts by mass to 20 parts by mass with respect to 100 parts by mass of the anionic group-modified polyvinyl alcohol resin, the molding processability of the water-soluble film and the flexibility of the package capsule can be further improved.

In addition to the plasticizer described above, the water-soluble film of the present invention may contain, within the range in which the object of the present invention is not impaired, commonly used plasticizers, for example, polyhydric alcohols such as trimethylolpropane, dipropylene glycol, propylene glycol, and 2-methyl-1,3-propanediol, polyethers such as polypropylene glycol, phenol derivatives such as bisphenol A and bisphenol S, amide compounds such as N-methylpyrrolidone, and compounds obtained by adding ethylene oxide to polyhydric alcohols such as pentaerythritol and sorbitol.

When a liquid detergent is enclosed in a capsule made of a water-soluble film containing a predetermined amount of such a plasticizer, the water-soluble film forming the capsule may lose haptics. It is presumed that this phenomenon is caused by a matter that the liquid detergent also contains a plasticizer, and the plasticizers in the water-soluble film and the liquid detergent move to achieve equilibrium. For this reason, in order to maintain the haptics of the water-soluble film forming the capsule with the liquid detergent enclosed, it is important that the total content of the plasticizer consisting of sorbitol, polyethylene glycol and/or polyglycerin, glycerin, and commonly used plasticizers is 25 parts by mass or more with respect to 100 parts by mass of the anionic group-modified polyvinyl alcohol resin. In the case where the content of the plasticizer is less than 25 parts by mass, the water-soluble film forming the capsule with the liquid detergent enclosed is likely to lose haptics. An upper limit of the total content of the plasticizer is 50 parts by mass with respect to 100 parts by mass of the anionic group-modified polyvinyl alcohol resin. In the case where the total content of the plasticizer is more than 50 parts by mass, the tensile strength of the water-soluble film is likely to decrease and the plasticizer is likely to precipitate on the surface of the water-soluble film. A preferred total content of the plasticizer is 25 parts by mass to 50 parts by mass, more preferably 25 parts by mass to 40 parts by mass, and furthermore preferably 28 parts by mass to 35 parts by mass with respect to 100 parts by mass of the anionic group-modified polyvinyl alcohol resin.

The anionic group-modified polyvinyl alcohol resin used in the present invention may turn yellow due to heating or the like during film production or molding of the produced water-soluble film, and a capsule which is obtained by molding the produced water-soluble film and in which a liquid detergent and/or a powder detergent is enclosed may also become colored due to deterioration over time during the storage. In order to prevent such yellowing or deterioration, it is preferable to contain a sulfite as an antioxidant. Examples of the sulfite include sodium sulfite, sodium hydrogen sulfite, sodium metabisulfite, potassium sulfite, potassium metabisulfite, calcium sulfite, and ammonium sulfite. In particular, sodium sulfite is preferable. These sulfites may be used alone or in combination. The sulfite contained in the water-soluble film for a detergent package capsule may be the same as or different from the sulfite contained in a detergent to be enclosed. However, in a water-soluble film containing a large amount of sulfite, the sulfite may precipitate during the storage. Therefore, the content of the sulfite is preferably 0.1 parts by mass to 1.9 parts by mass, more preferably 0.1 parts by mass to 1.5 parts by mass, and furthermore preferably 0.1 parts by mass to 1.1 parts by mass with respect to 100 parts by mass of the anionic group-modified polyvinyl alcohol resin. According to the content of the sulfite within this range, yellowing due to the heating during the film production or the molding and the coloring of the capsule with a detergent enclosed can be prevented, and the precipitation of the sulfite can be prevented during the storage of the produced water-soluble film.

The water-soluble film of the present invention may contain other added substances within a range in which physical properties of the water-soluble film are not impaired. The other added substances may include a surfactant, a water-soluble polymer, and an additive.

Examples of the surfactant include a nonionic surfactant, an anionic surfactant, a cationic surfactant, and an amphoteric surfactant. Among theses, the surfactant is preferably a polyoxyethylene lauryl ether acetate sodium salt, a polyoxyethylene alkyl ether phosphate potassium salt, a di-2-ethylhexyl sulfosuccinate sodium salt, or a polyoxyethylene alkyl ether sulfate sodium salt. These may be used alone or in combination. The content of the surfactant is preferably 0.1 parts by mass to 2.0 parts by mass with respect to 100 parts by mass of the anionic group-modified polyvinyl alcohol resin. The surfactant can impart releasability from a cast surface during the production of the water-soluble film and can facilitate processing such as sealing (water-sealing or heat-sealing) when producing the liquid detergent package capsule, the powder detergent package capsule, or the package capsule with a powder detergent or a liquid detergent enclosed.

Examples of the water-soluble polymer include sodium polyacrylate, polyethylene oxide, polyvinyl pyrrolidone, dextrin, chitosan, chitin, methyl cellulose, and hydroxy ethyl cellulose. Examples of the additive include various fillers such as silica, aluminosilicate (zeolite), titanium oxide, talc, starch, and crosslinked acrylic fine particles, colorants, flavoring agents, extenders, defoamers, release agents, ultraviolet absorbents, rust preventive agents, liquid paraffins, fluorescent whitening agents, chelating agents, aversive agents such as denatonium benzoate, fatty acid-based substances, and inorganic powders.

A method for producing the water-soluble film of the present invention includes a step of preparing an aqueous solution and a film production step of producing the water-soluble film.

In the step of preparing an aqueous solution, a method for preparing the aqueous solution is not particularly limited, and examples thereof include a method of dissolving the anionic group-modified polyvinyl alcohol resin, the plasticizer, the surfactant, and the additive such as a filler in a dissolution tank and a method of kneading the anionic group-modified polyvinyl alcohol resin in a wet state with the plasticizer, the surfactant, and the additive such as a filler by using a twin-screw extruder.

In the step of producing the water-soluble film, a method of producing a water-soluble film containing the anionic group-modified polyvinyl alcohol resin is not particularly limited, and adoptable examples thereof include a method of applying an aqueous solution or an aqueous solvent solution of a composition of the water-soluble film containing the anionic group-modified polyvinyl alcohol resin to a surface of a rotating metal roll or the like (including a surface of a metal belt) which is a support member using a known device, and performing peeling from the surface of the metal roll or the like (including the surface of the metal belt) and winding, while drying. As the supplying method, known methods such as a solution casting method (casting method) and a roll coating method can be adopted.

Further, as necessary, to perform an embossing treatment, for example, matte embossing treatment on the water-soluble film, an embossing pattern may be applied while heating and pressing the water-soluble film between biaxial rollers having embossed uneven shapes on surfaces thereof.

The moisture content of the water-soluble film of the present invention obtained by film production is preferably 4.0 mass % to 9.0 mass %, more preferably 4.5 mass % to 8.0 mass %, and furthermore preferably 5.0 mass % to 7.5 mass % in a normal temperature, normal pressure, and normal humidity environment. In the case where the moisture content is less than 4.0 mass %, the flexibility of the water-soluble film tends to decrease, whereas in the case where the moisture content is more than 9.0 mass %, the water-soluble films tend to adhere to each other easily.

The thickness of the water-soluble film of the present invention obtained by the film production is preferably 40 μm to 120 μm, more preferably 50 μm to 110 μm, and furthermore preferably 60 μm to 90 μm. A water-soluble film having a thickness of less than 40 μm tends to have insufficient tensile strength when being used for a detergent package capsule, and a water-soluble film having a thickness more than 120 μm tends to have reduced formability when being formed into a detergent package capsule.

It is preferable that the obtained water-soluble film has a haze of 50% or less measured according to JIS K7136 (2000), which leads to good transparency. A water-soluble film having a haze more than 50% tends to have insufficient transparency.

The water-soluble film of the present invention may be formed of only one layer or may be formed by stacking two or more water-soluble films of the same type or different types having a composition of the water-soluble film according to the present invention. The detergent package capsule using such a water-soluble film of the present invention is a capsule that is formed by bonding end edges of at least two of the water-soluble films of the present invention and that includes a detergent enclosed therein. The detergent package capsule is produced by being filled with contents and being sealed with a heat-seal or a water-seal. The detergent package capsule is preferably formed by a thermoforming method or a vertical-form-fill-seal (VFFS) method, and more preferably formed by a thermoforming method.

Here, the detergent package capsule produced by a thermoforming method can be produced, for example, by following the water-soluble film along an inner wall surface of a cavity having a predetermined capacity formed in a mold to form a bottom water-soluble film formed with a recess having a predetermined capacity, filling the recess with a predetermined amount of detergent, then, applying a predetermined amount of water to one surface side of a top water-soluble film made of the water-soluble film, and crimping a predetermined surface of the bottom water-soluble film located at a peripheral edge of the cavity in the mold and the water-coated surface of the top water-soluble film. The depth of the detergent package capsule can be appropriately adjusted within a range that can withstand deep drawing.

The detergent package capsule produced by the VFFS method can be produced by folding the water-soluble film vertically, heating and sealing overlapped ends vertically and horizontally, filling the folded water-soluble film with the detergent, and sealing an upper portion thereof.

A powder detergent and a liquid detergent and/or a gel detergent may be enclosed in the detergent package capsule of the present invention. A single detergent, that is, a powder detergent or a liquid detergent may be enclosed and packaged, or two or more of a powder detergent and a liquid detergent may be separately enclosed and packaged to form a single-package-type multi-chamber detergent package capsule.

### EXAMPLES

Examples of the present invention will be described in detail below, but the scope of the present invention is not limited to these Examples.

### (Anionic Group-Modified Polyvinyl Alcohol Resin (Modified PVA Resin))

At least two of the following plasticizers were added to a maleic acid-modified polyvinyl alcohol resin, as a modified PVA resin, having a degree of modification, a degree of polymerization, an average degree of saponification, and a 4 mass % aqueous solution viscosity at 20° C. (hereinafter, referred to as 4 mass % viscosity) shown in Table 1 below.

### [Table 1]

TABLE 1

| | A-1 |
|---|---|
| Degree of modification (mol %) | 1.9 |
| Degree of polymerization | 1700 |
| Average degree of saponification (mol %) | 88 |
| 4 mass % viscosity (mPa · s) | 28 |

### (Plasticizer and Other Added Substances)

### Plasticizer

B-1: sorbitol
B-2: diglycerin
B-3: polyethylene glycol (PEG 200)
B-4: glycerin
Other additives
Antioxidant
C-1: sodium sulfite
Surfactant
D-1: polyoxyethylene alkyl ether phosphate potassium salt

### Example 1

### (Preparation of Water-Soluble Film Composition)

A modified PVA resin A-1 shown in Table 1 of 100 parts by mass was used, and the above plasticizers, antioxidant, and surfactant were added as shown in Table 2, and the mixture was kneaded in a wet state by using a twin-screw extruder to prepare a water-soluble film composition having a concentration of 55 mass % to 59 mass %.

### (Film Production)

A water-soluble film composition prepared to have the composition shown in Table 2 was cast from a T die at 90° C. onto a metal roll surface (first drying roll) whose surface temperature was maintained at 86° C. The water-soluble film composition was dried for 80 seconds while rotating the metal roll (first drying roll), was peeled off from the first drying roll and then, dried by second and subsequent drying rolls such that one surface and the other surface of the PVA film were alternately brought into contact with the respective drying rolls, thereby producing a water-soluble film having a thickness of 90 μm.

### Examples 2 to 5 and Comparative Examples 1 to 3

In Examples 2 to 5 and Comparative Examples 1 to 3, the compositions of the water-soluble film composition were prepared in the same manner as in Example 1, and a water-soluble film having a thickness of 90 μm was produced in the same manner as in Example 1, except that the composition of the water-soluble film composition was changed to the compositions shown in Table 2.

### (Precipitation Evaluation Test)

One water-soluble film obtained in each of Examples 1 to 5 and Comparative Examples 1 to 3 was cut into a size of 100 mm×100 mm and stored in an environment of 23° C. and 33% RH for two months. After that, the water-soluble film was visually confirmed. One that did not have white precipitates was evaluated as pass (A), and one that had white precipitates was evaluated as fail (B). The results are also shown in Table 2.

### (Liquid Detergent Package Capsule Haptics Retention Test)

### [Preparation of Liquid Detergent]

A liquid detergent containing 72.9 mass % of a surfactant, which contained a polyoxyethylene alkyl ether, a linear alkylbenzene sulfonate, an alkyl ether sulfate ester salt, and a polyethylene glycol monolaurate, 5.1 mass % of glycerin, 14.5 mass % of polyethylene glycol (PEG 400), and 7.5 mass % of water was prepared by mixing 21.2 mass % of TOP SUPER NANOX (trade name, manufactured by Lion Corporation), 73.7 mass % of EMANON 1112 (trade name, manufactured by Kao Corporation), and 5.1 mass % of glycerin.

[Production of Liquid Detergent Package Capsule]

One water-soluble film for a detergent package obtained in each of Examples and Comparative Examples was used as the bottom and was set on a mold having a cavity (a box-shaped cavity having an opening area of 2000 mm², a depth of 15 mm, and rounded corners) in a stretched state without wrinkles or sagging. The water-soluble film was heated at about 90° C. for 5 seconds, and the water-soluble film was made to follow the cavity by vacuum molding to form a recessed water-soluble film sheet. The recess of the water-soluble film sheet on the cavity was filled with about 22 mL of the prepared liquid detergent. Next, the water-soluble film obtained in the same manner was used as a top water-soluble film, and a water-wetted lab towel (trade name, manufactured by Unichemy Co., Ltd.) was used to apply water to the top water-soluble film to a water application amount of 44 g/m² to 54 g/m². The water-applied top water-soluble film was immediately laminated to the water-soluble film sheet as the bottom side at an edge of the recess to be press-bonded under evacuation by using a 1.5 kg metal roll, followed by holding for about 1 minute and 30 seconds, and then the evacuation was stopped, and a capsule sheet was removed from the cavity, and cut to create a liquid detergent package capsule.

### [Capsule Height Maintenance Rate Measurement]

The liquid detergent package capsule was removed from the cavity, and then left to stand at room temperature for about 7 minutes. At this time, an initial height (h0) of this liquid detergent package capsule was measured by using a height gauge (manufactured by Mitutoyo Corporation: absolute digimatic height gage). This liquid detergent package capsule was stored for another 7 days in an environment of 23° C. and 50% RH. At this time, a height (h1) of this liquid detergent package capsule after the storage was measured in the same manner by using the height gauge. A capsule height maintenance rate (%) was calculated by the following formula, as an index of the liquid detergent package capsule haptics retention.

$$Capsule height maintenance rate ( \% ) = h 1 / h 0 \times 100$$

The capsule height maintenance rate of 86% or more was evaluated as A, and the capsule height maintenance rate of less than 86 was evaluated as B. The A means that the capsule has good haptics and has an appearance that is preferred by consumers. The results are summarized in Table 2.

(Tensile Modulus of Water-Soluble Film in Contact with Powder Detergent)
[Production of Water-Soluble Film in Contact with Powder Detergent Ingredient]

One water-soluble film obtained in each of Examples 1 to 5 and Comparative Examples 1 to 3 was cut to a size of 330 mm×65 mm, folded in half along its long side such that the air surface during the casting was on the inside, and two side edges of the two ends were heat-sealed by using a shop sealer FS-315 (trade name, manufactured by Fuji Impulse Co., Ltd.) to produce a flat bag of 165 mm×65 mm. This flat bag was filled with 35 g of sodium carbonate, which is a powder detergent ingredient, the remaining side was heat-sealed, five holes were made in a top surface of the flat bag, and the flat bag was exposed and stored in an environment of 50° C. and 50% RH for 7 days. The flat bag was then cut to remove the sodium carbonate, and the sodium carbonate adhering to the film was wiped off. At this time, a part corresponding to a bottom surface of the flat bag during the storage of the sodium carbonate package was used as a water-soluble film in contact with a powder detergent ingredient.

[Production of Water-Soluble Film in Contact with Powder Detergent]

One water-soluble film obtained in each of Examples 1 to 5 and Comparative Examples 1 to 3 was cut to a size of 330 mm×75 mm, folded in half along its long side such that the air surface during the casting was on the inside, and two side edges of the two ends were heat-sealed by using a shop sealer FS-315 (trade name, manufactured by Fuji Impulse Co., Ltd.) to produce a flat bag of 165 mm×75 mm. This flat bag was filled with 50 g of a powder detergent for dishwashers (manufactured by Reckitt Benckiser: Finish), the remaining side was heat-sealed, five holes were made in a top surface of the flat bag, and the flat bag was exposed and stored in an environment of 50° C. and 50% RH for 7 days. The flat bag was then cut to remove the powder detergent, and the detergent adhering to the film was wiped off. At this time, a part corresponding to a bottom surface of the flat bag during the storage of the powder detergent package was used as a water-soluble film in contact with a powder detergent.

[Tensile Modulus Measurement Test of Water-Soluble Film in Contact with Powder Detergent Ingredient and Water-Soluble Film in Contact with Powder Detergent]

The water-soluble film in contact with a powder detergent ingredient and the water-soluble film in contact with a powder detergent were stored in an environment of 23° C. and 33% RH for one day, and then a tensile test was performed based on JIS K7127 (1999) by using a tensile tester AGS-1 kN (trade name, manufactured by Shimadzu Corporation). Measurement conditions are as follows.
Measurement environment: 23° C., 50% RH
Film test piece: width 15 mm×length 150 mm
Distance between chucks: 100 mm
Tensile test speed: 300 mm/min

At this time, the tensile modulus was evaluated as A in the case where the tensile modulus was less than 220 MPa, and was evaluated as B in the case where the tensile modulus was 220 MPa or more. The A means that the film is flexible and the embrittlement of the water-soluble film due to packaging a powder detergent is prevented. The results are summarized in Table 2.

TABLE 2

| | | | Water-soluble film composition | | | | |
|---|---|---|---|---|---|---|---|
| | | | Modified PVA | Plasticizer | | Antioxidant | Surfactant |
| | | Thickness | resin (parts by | Each (parts | Total (parts | (parts by | (parts by |
| | | (μm) | mass) | by mass) | by mass) | mass) | mass) |
| Ex. | 1 | 90 | A-1 (100) | B-1 (10) | 33 | C-1 (0.9) | D-1 (0.3) |
| | | | | B-2 (8) | | | |
| | | | | B-4 (15) | | | |
| | 2 | | | B-1 (10) | | | |
| | | | | B-3 (8) | | | |
| | | | | B-4 (15) | | | |
| | 3 | | | B-1 (10) | | | |
| | | | | B-2 (15) | | | |
| | | | | B-4 (8) | | | |
| | 4 | | | B-1 (10) | | | |
| | | | | B-3 (15) | | | |
| | | | | B-4 (8) | | | |
| | 5 | | | B-1 (10) | | C-1 (0.6) | |
| | | | | B-2 (8) | | | |
| | | | | B-4 (15) | | | |
| Comp. | 1 | | | B-1 (20) | 30 | C-1 (0.9) | |
| Ex. | | | | B-4 (10) | | | |
| | 2 | | | B-1 (10) | 20 | | |
| | | | | B-4 (10) | | | |
| | 3 | | | B-1 (15) | 30 | | |
| | | | | B-4 (15) | | | |

| | | Water-soluble film performance | | | |
|---|---|---|---|---|---|
| | | | | Water-soluble film | |
| | | Water-soluble | Liquid detergent | in contact with | Water-soluble film |
| | | film | package capsule | powder detergent | in contact with |
| | | Precipitation | Capsule height | ingredient | powder detergent |
| | | evaluation | maintenance | Tensile modulus | Tensile modulus |
| | | test | rate (%) | (MPa) | (MPa) |
| Ex. | 1 | A | A | A | A |
| | | | (90) | (56) | (116) |
| | 2 | A | A | A | A |
| | | | (90) | (61) | (148) |
| | 3 | A | A | A | A |
| | | | (90) | (51) | (122) |
| | 4 | A | A | A | A |
| | | | (90) | (63) | (132) |
| | 5 | A | A | A | A |
| | | | (90) | (59) | (121) |
| Comp. | 1 | B | A | A | A |
| Ex. | | | (88) | (189) | (147) |
| | 2 | A | B | B | B |
| | | | (82) | (281) | (285) |
| | 3 | A | A | B | B |
| | | | (90) | (220) | (220) |

As is clear from Table 2, in the case where the content of sorbitol is 10 parts by mass, the content of the polymer consisting of PEG 200, which is polyethylene glycol, and/or diglycerin is 8 parts by mass to 15 parts by mass, and the content of the total plasticizer including sorbitol, PEG 200, and/or diglycerin is 33 parts by mass with respect to 100 parts by mass of the modified PVA resin as shown in Examples 1 to 5, in the precipitation evaluation test of the obtained water-soluble film, sorbitol can be prevented from precipitating on the surface of the water-soluble film and reducing transparency even after the long-term storage.

Furthermore, as is clear from Table 2, the capsule height maintenance rate (%) as shown in Examples 1 to 5 as an index for evaluating the liquid detergent package capsule haptics retention shows a high value of 90% or more, and thus even a liquid detergent package capsule with a liquid detergent enclosed can maintain an excellent haptics.

Furthermore, as is clear from Table 2, as shown in Examples 1 to 5, the tensile modulus of each of the water-soluble film in contact with a powder detergent ingredient and the water-soluble film in contact with a powder detergent is less than 220 MPa, and thus the breakage of the powder detergent package capsule due to embrittlement of the water-soluble film caused by the migration of the plasticizer to the powder detergent can be prevented.

### INDUSTRIAL APPLICABILITY

A water-soluble film for a detergent package capsule according to the present invention can be used for a detergent package capsule with a liquid detergent and/or a powder detergent enclosed, and it can be stored for a long period of time, which can contribute to a production schedule of the detergent package capsule over a long period of time.

1. A water-soluble film for a detergent package capsule, comprising:
an anionic group-modified polyvinyl alcohol resin; and
a plasticizer including sorbitol and a polymer consisting of polyethylene glycol and/or polyglycerin, wherein
a content of the sorbitol is 6 parts by mass to 15 parts by mass, a content of the polymer is 3 parts by mass to 15 parts by mass, and a content of the plasticizer is 25 parts by mass to 50 parts by mass with respect to 100 parts by mass of the anionic group-modified polyvinyl alcohol resin.

2. The water-soluble film for a detergent package capsule according to claim 1, wherein
the anionic group-modified polyvinyl alcohol resin has a modification type of maleic acid modification and a degree of modification of 0.5 mol % to 6.0 mol %.

3. The water-soluble film for a detergent package capsule according to claim 1, wherein
a total content of the sorbitol and the polymer consisting of the polyethylene glycol and/or the polyglycerin is 18 parts by mass to 30 parts by mass with respect to 100 parts by mass of the anionic group-modified polyvinyl alcohol resin.

4. The water-soluble film for a detergent package capsule according to claim 1, wherein
the plasticizer further contains glycerin, and a content of the glycerin is 1 part by mass to 32 parts by mass with respect to 100 parts by mass of the anionic group-modified polyvinyl alcohol resin.

5. The water-soluble film for a detergent package capsule according to claim 1, further comprising:
a sulfite, wherein
a content of the sulfite is 0.1 parts by mass to 1.9 parts by mass with respect to 100 parts by mass of the anionic group-modified polyvinyl alcohol resin.

6. The water-soluble film for a detergent package capsule according to claim 5, wherein
the sulfite is sodium sulfite.

7. The water-soluble film for a detergent package capsule according to claim 1, wherein
when a capsule formed of the water-soluble film for a detergent package capsule is vacuum-molded with a box-shaped cavity having an opening area of 2000 mm², a depth of 15 mm, and rounded corners, and 22 mL of a liquid detergent containing 72.9 mass % of a surfactant, 5.1 mass % of glycerin, 14.5 mass % of polyethylene glycol (PEG 400), and 7.5 mass % of water is enclosed in the capsule, a height retention rate is 86% or more after storage for 7 days at 23° C. and 50% RH, the surfactant containing a polyoxyethylene alkyl ether, a linear alkylbenzene sulfonate, an alkyl ether sulfate ester salt, and a polyethylene glycol monolaurate.

8. The water-soluble film for a detergent package capsule according to claim 1, wherein
when a 165 mm×65 mm flat bag formed of the water-soluble film for a detergent package capsule is filled with 35 g of sodium carbonate, the water-soluble film in contact with a powder detergent ingredient obtained after exposure and storage for 7 days in an environment of 50° C. and 50% RH has a tensile modulus in a tensile modulus measurement test of less than 220 MPa.

9. A detergent package capsule, comprising
a liquid detergent and/or a powder detergent enclosed in a capsule formed of the water-soluble film for a detergent package capsule according to claim 1.
